(19) United States
(12) Patent Application Publication
(10) Pub. No.: US 2024/0426576 A1
(43) Pub. Date: Dec. 26, 2024

(54) OBSERVING DEVICE COMPRISING INDEPENDENT OPTICAL AND OPTRONIC CHANNELS AND VEHICLE EQUIPPED WITH SUCH A DEVICE

(71) Applicant: SAFRAN ELECTRONICS & DEFENSE, PARIS (FR)

(72) Inventors: Arnaud Pierre Henri MORAILLON, MOISSY-CRAMAYEL (FR); Julien ARAGONES, MOISSY-CRAMAYEL (FR); Claire TAFANELLI, MOISSY-CRAMAYEL (FR); Christophe GUETTIER, MOISSY-CRAMAYEL (FR); Marie-Axelle Jeanne BORRIELLO, MOISSY-CRAMAYEL (FR); Fabrice LARRIBE, MOISSY-CRAMAYEL (FR); Florian Franck Maxence BERTELLI, MOISSY-CRAMAYEL (FR)

(21) Appl. No.: 18/575,239

(22) PCT Filed: Jun. 23, 2022
(86) PCT No.: PCT/EP2022/067200

§ 371 Date: Dec. 28, 2023

(30) Foreign Application Priority Data
Jun. 28, 2021 (FR) FR2106898

(51) Int. Cl. F41G 3/02; F41G 3/06; F41G 3/16; F41G 3/22; G01S 17/89

(52) U.S. Cl. CPC F41G 3/02; F41G 3/06; F41G 3/165; F41G 3/22; G01S 17/89

(57) ABSTRACT

An observing device includes an orientable optronic sight connected to a first electronic unit arranged to command acquisition according to image-capture parameters and an orientable optical sight connected to a second electronic unit arranged to communicate to the first electronic control unit image-capture parameters of the optical sight, the first electronic unit having a slave operating mode in which the optronic sight is commanded to make acquisitions according to the image-capture parameters of the optical sight and at least one autonomous operating mode in which the optronic sight is commanded to make acquisitions independently of the image-capture parameters of the optical sight.

The present invention relates to the field of observation and surveillance of the surroundings of a vehicle, such as a military vehicle, e.g., a military land vehicle.

### BACKGROUND OF THE INVENTION

It is known for vehicles equipped with an optical sight (direct optical channel), such as, a periscope, episcope or optical scope allowing an operator (for example, vehicle commander), to observe the vehicle's surroundings, at short, medium or long distances.

Certain vehicles, in particular, those equipped with a gun, are also equipped with optronic observation and surveillance equipment, for example, an optronic sight comprising a rotating support on which optronic sensors are mounted and a range-finder connected to an electronic control unit also connected to a motorisation system of the support. The electronic control unit is programmed to acquire images via the optronic sensors, detect threats and/or targets and acquire information relating to said threats and/or targets, such as, the distance, angular position, relative velocity (also known as objective acquisition). The electronic control unit is also programmed to automatically orientate the support so as to track threats and/or targets (i.e., to point the support, and thus the weapon whose movements are controlled by those of the support, at threats and/or targets) or to surveil the vehicle's surroundings over a given angular clearance. A human-machine interface is connected to the electronic control unit to allow the operator to select the sighting line, spectral channel (day/night) and field covered by the optronic sensors (zoom level). The optronic observation sight thus makes it possible to enhance the operator's knowledge of the vehicle's surroundings and to ensure an aim and therefore more accurate shots than the optical sight allows.

Since the operator cannot use both the optical sight and optronic sight at the same time, there are two operating modes: one in which the optical sight is used by the operator and the optronic sight has its image-capture parameters (in particular, orientation and zoom level) modelled on those of the optical sight (the optronic sight is the slave of the scope); the other in which, conversely, the operator uses the optronic sight and the optical sight is the slave of the optronic sight.

### AIM OF THE INVENTION

The invention has the particular aim of improving the observation and surveillance capabilities of the operators of such vehicles.

### SUMMARY OF THE INVENTION

To this end, according to the invention, a device is provided according to claim 1.

Thus, in autonomous operating mode, the optronic sight continues its acquisitions while the operator is using the optical sight, e.g., to supplement the observations made by the operator via the optical sight or to perform automatic observations to relieve the operator. It is therefore possible to supply additional information to the operator by limiting the increase in the operator's cognitive load.

The invention also relates to a vehicle comprising a body surmounted by such a device.

Other characteristics and advantages of the invention appear on reading the following description of a particular and non-limiting embodiment of the invention.

### BRIEF DESCRIPTION OF THE DRAWING

Reference is made to the accompanying drawings, among which:

FIG. 1 is a schematic front view of a vehicle according to the invention;

FIG. 2 is a schematic front view of an observing device according to the invention;

FIG. 3 is a schematic top view showing the ranges covered by, respectively, the optical sight and optronic sight, in autonomous operating mode;

FIG. 4 is a schematic view showing the division of the range covered by the optronic sight in observation sectors from a panoramic image supplied by the optronic sight;

FIG. 5 is a flowchart showing the method of controlling the optronic sight in autonomous operating mode.

### DETAILED DESCRIPTION OF THE INVENTION

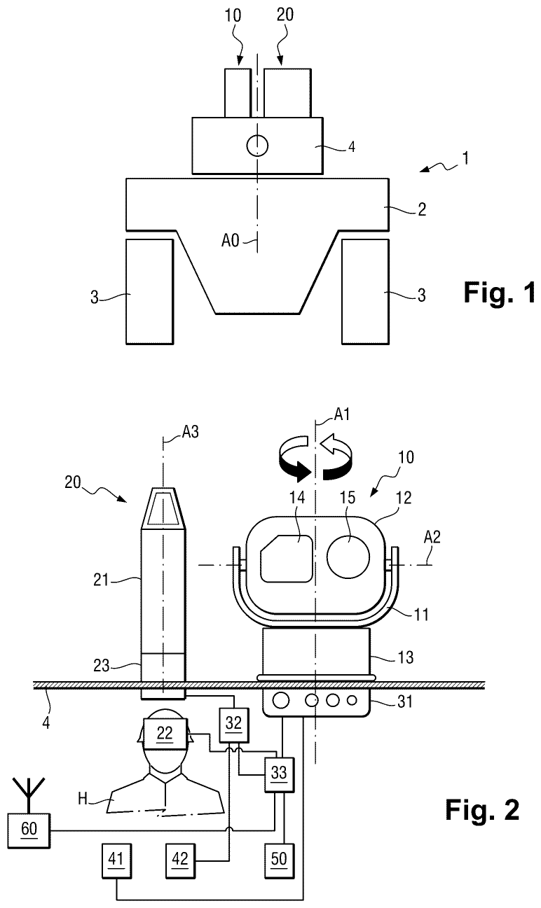

In reference to FIGS. 1 and 2, the invention is described, in this case, in application of a vehicle, generally designated in 1, comprising a body 2, in this case, carried by wheels 3 and surmounted by a turret 4 armed with a gun and mounted on the body 2 to pivot around a substantially vertical axis A0 whenever the vehicle rests on a horizontal plane. Vehicle 1 is, in this case, designed for a crew of at least three persons, namely a driver, gunner and vehicle commander.

The turret 4 of the vehicle 1 is equipped with a device for observing the surroundings of the vehicle 1 by the vehicle commander H. In this case, we are interested in the control station of the vehicle commander, but needless to say, the driver's station, and/or the gunner's station, may be equipped with an identical or similar observing device, or benefit from the images provided by that of the vehicle commander.

The observing device comprises optronic equipment, e.g., an optronic sight 10 and an optical sight 20.

The optronic sight 10 comprises a support 11 that is mounted to pivot on the upper surface of the turret 4 around an axis A1 parallel to the axis A0 and that carries a sensor block 12 mounted on the support 11 to pivot around an axis A2 perpendicular to the axis A1. Thus, the sensor block 12, and therefore the sighting line LV10 of the optronic sight 10, is orientable in a bearing around the axis A1 and in site (or elevation) around the axis A2.

The optronic sight 10 comprises a motorisation system, symbolised in 13 and in a manner known per se, allowing the sensor block 12 to be orientated in a bearing around the A1 axis and a motorisation system embedded on the support 11, and in a manner known per se, allowing the sensor block 12 to be orientated in site around the A2 axis. The optronic sight 10 also comprises, in a manner known per se, the first position sensors, such as angle encoders, making it possible to know the orientation of the sensor block 12 in a bearing around the axis A1 and in site around the axis A2. Preferably, the electronic sight 10 also comprises, in a manner known per se, second position sensors, such as, accelerometers and gyrometers, making it possible to know the position of the sensor block 12 within a pre-determined reference system. The position sensors therefore make it possible to know the direction of the sighting line LV10 of the optronic sight 10, at all times.

The sensor block 12 comprises, in this case, an optronic sensor 14 and a range-finder 15. The optronic sensor 14 comprises a day channel and a night channel.

The optronic sensor 14, the motorisation system 13 and the position sensors are connected to a first electronic unit 31 arranged to control the image acquisition according to image-capture parameters. The image-capture parameters, in this case, comprise the sighting line (the orientation of the sensor block 12 around the axes A1 and A2), the spectral channel (day/night) and the field of view covered by the optronic sensors (zoom level). The electronic unit 31 comprises, in a manner known per se, both a processor and a memory containing computer programs that may be executed by the processor.

The range-finder 15 is also connected to the first electronic unit 31 that is also arranged to control the performance of telemetry measurements according to the sighting line LV10.

A control instrument 41, such as a joystick-type lever, is connected to the first electronic unit 31 to allow the vehicle commander to send control signals to the first electronic unit 31 in order to orientate the sensor block 12, select the spectral channel and zoom level, and control the telemetry measurements.

The optical sight 20 is, in this case, in the form of a periscope or episcope 21 mounted on the top of the turret 4 to be orientable in a bearing around an axis A3 parallel to the axis A2. In a manner known per se, the periscope 21 comprises a group of lenses and mirrors allowing the vehicle commander to see what is present within a sighting line LV20 of the periscope 21, with light rays entering the periscope 21 through an optical input element located outside the vehicle and exiting through an optical output element 22 located inside the vehicle. In this case, at least one of the mirrors is orientable around an axis perpendicular to the axis A3 to allow the sighting line to be orientated in site around the said axis. The group of lenses comprises at least one mobile lens allowing a focal length adjustment authorising multiple zoom levels that may be selected by the vehicle commander. The movement of the mobile lens is provided by a motor (not represented).

The optical sight 20 is equipped with a motorisation system, symbolised in 23 and in a manner known per se, allowing the periscope 21 to be orientated in a bearing around the axis A3 and possibly the orientable mirror in site. The optical sight 20 also comprises, in a manner known per se, position sensors, such as angle encoders, making it possible to know the orientation of the periscope 21 in a bearing around the axis A3 and that of the orientable mirror in site. The position sensors therefore make it possible to know the direction of the sighting line LV20, at all times.

The motorisation system 23, position sensors and zoom motor are connected to a second electronic unit 32 connected to a control instrument 42, such as a joystick-type lever, to allow the vehicle commander to send control signals to the second electronic unit 32 in order to orientate the periscope 21 and the mirror, and select the zoom level. The image-capture parameters, in this case, comprise the sighting line (the orientation of the periscope 21 around the axis A3 and the mirror around the corresponding transverse axis) and the field of view covered by the group of lenses and visible via the optical output element 22 (zoom level). The electronic unit 32 comprises, in a manner known per se, both a processor and a memory containing computer programs that may be executed by the processor.

The first electronic unit 31 and the second electronic unit are connected to a third electronic unit 33 that is arranged to:
process images supplied by the optronic sensors;
allow the vehicle commander to select an operating mode between a master optical/slave optronic operating mode, a slave optical/master optronic operating mode, and an autonomous optronic operating mode;
transmit, to the electronic unit 31, the image-capture parameters received from the electronic unit 32 when the selected operating mode is the master optical/slave optronic operating mode;
transmit, to the electronic unit 32, the image-capture parameters received from the electronic unit 31 when the selected operating mode is the slave optical/master optronic operating mode;
display, on a display device (preferably a touch screen) 50 connected to the electronic unit 33 and located in the vicinity of the vehicle commander, the images supplied by the optronic sensors and processed, as well as the telemetry measurements, when the operating mode selected is the slave optical/master optronic operating mode.

The electronic unit 33 comprises, in a manner known per se, both a processor and a memory containing computer programs that may be executed by the processor.

In master optical/slave optronic operating mode, the vehicle commander uses the optical sight 20 (they control it by means of the control instrument 42, the second electronic unit 32 to orientate the sighting line LV20 in the desired direction with a desired zoom level) and the image-capture parameters of the optronic sight 10 are set by the electronic unit 31 to be identical to those of the optical sight 20.

In slave optical/master optronic operating mode, the vehicle commander uses the optical sight 10 (they control it by means of the control instrument 41, the first electronic unit 31 to orientate the sighting line LV10 in the desired direction with a desired zoom level) and the image-capture parameters of the optical sight 20 are set by the electronic unit 32 to be identical to those of the optronic sight 10. The first electronic unit 31 is, e.g., programmed to automatically orientate the support 11 and the sensor block 12 so as to track threats and/or targets (i.e., to point the support 11 and sensor block 12, and thus the weapon whose movements are controlled by those of the support 11 and sensor block 12, to threats and/or targets) or to surveil the vehicle's surroundings over a given angular clearance. The captured images, generally in the form of a video stream, are displayed on the screen 50.

These two operation modes, as well as the processing performed on the images supplied by the optronic sensors, are known per se and will not be described in greater detail here.

In autonomous optronic operating mode, and in accordance with the invention, the optronic sight 10 is controlled to make acquisitions independently of the image-capture parameters of the optical sight 20 while the optical sight 20 is used by the vehicle commander.

In particular, the first electronic unit 31 is arranged to point the optronic sight 10 in a different direction from that of the optical sight 20 and acquire images in that direction. The image-capture parameters are determined and communicated to the first electronic unit 31 by the third electronic unit 33.

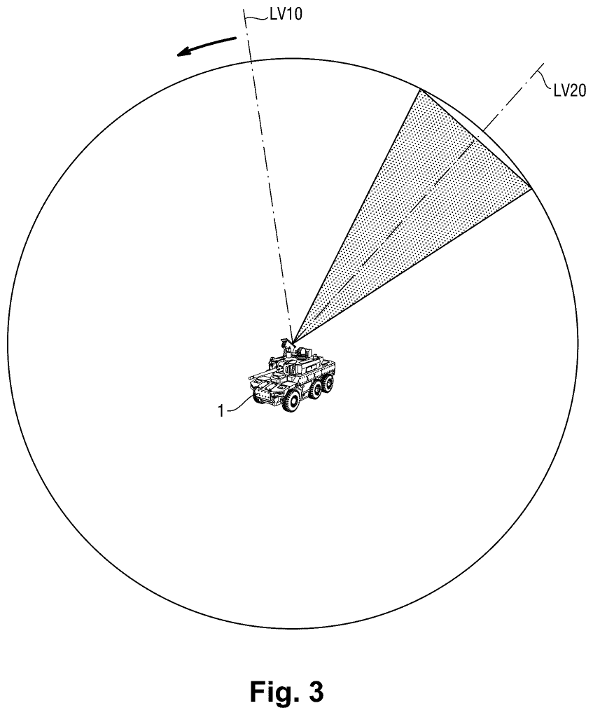

According to a first operating mode, the electronic unit 31 controls a 360° scan of the vehicle's surroundings (see FIG. 3) to form a panoramic image and, if the situation allows, telemetry measurements to create a telemetry map of the detected points of interest.

The third electronic unit 33 is programmed to process the images supplied by the optronic sight 10, detect points and/or zones of interest, and present information to the vehicle commander relating to the detected points or zones of interest. Preferably, the electronic unit 33 creates a panoramic image displayed on the screen 50 with the points of interest and associated information. In a particularly advantageous manner, the optical output element 22 is equipped with a liquid crystal matrix that allows information to be displayed on the optical output element 22 while allowing a transparent view of the scene as seen through the group of lenses. This information may comprise an upper or lower band schematically representing a panorama of the surroundings with symbols representing the points of interest (e.g., a symbol for the allies, a symbol for the enemies, one for each element of the surroundings that may be encountered: road, building, river, cliff, ditch . . . ) and information associated with each point of interest, such as the distance obtained by telemetry.

The third electronic unit 33 is programmed to determine contextualisation information making it possible to spatially connect the information relating to the detected points of interest and the field of view covered by the optical sight 20: for example, the electronic unit 33 symbolises by a vertical line, in the displayed band that, in this case, represents a 360° field, the sighting line of the optical sight 20 and, optionally, by a frame, the limits of the field of view covered on these 360° by the optical sight 20. Advantageously, the third electronic unit 33 is programmed to transfer, on the liquid crystal matrix, the information (distance and ally/enemy symbol, etc.) relating to the points of interest appearing in the field of view covered by the optical sight 20, at the location where they are situated in the scene being viewed.

With regard to these points of interest and the information relating to them, the third electronic unit 33 is advantageously programmed to, in autonomous operating mode, detect each target present in the field of view of the optronic sensor 10, assess a level of dangerousness of each target according to data from the target, and update the threat level periodically after a pre-determined period of time. In this case, the target data is as follows:
a target type from a target library;
a position of the target;
a trajectory of the target;
a weapon orientation of the target.

According to an advantageous version of the invention, the third electronic unit 33 is also programmed to determine, in autonomous operating mode, a priority level of the zones to be observed according to a level of complexity of each zone and/or a level of dangerousness of each zone. The greater the number of points of interest in a zone, the more complex the zone is. The greater the number of targets (or enemies, adopting the hypothesis that each enemy is not considered a target) in a zone, the more dangerous that zone is. The third electronic unit 33 then displays, in the band, zones with a priority number that depends on the level of dangerousness and/or the level of complexity such that the vehicle commander may choose to perform observations of these zones as a priority, by means of the optical sight 20.

The display of this information by the liquid crystal matrix is controlled by the electronic unit 33 and is activated and de-activated by the vehicle commander. Provision may be made for this information to remain displayed, or not, on the screen 50 when the display is de-activated on the liquid crystal matrix.

The device according to the invention also comprises particularly advantageous functions when several vehicles equipped with the device are in formation.

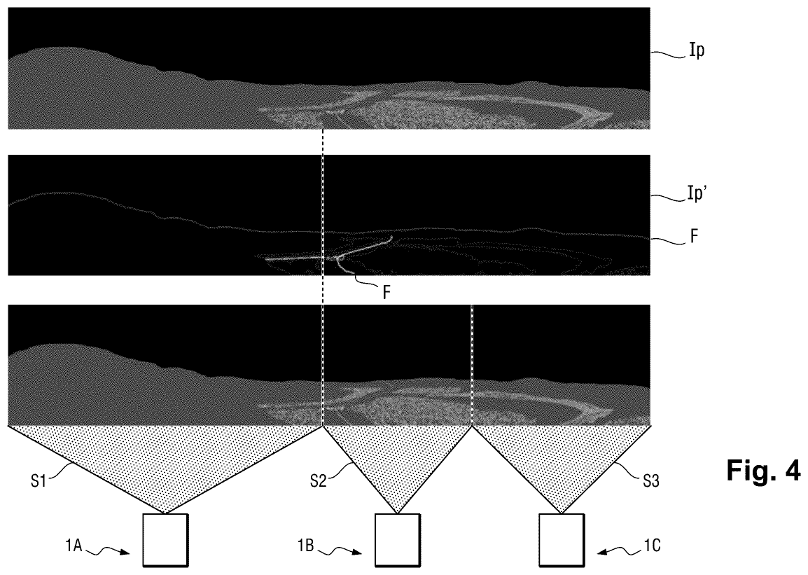

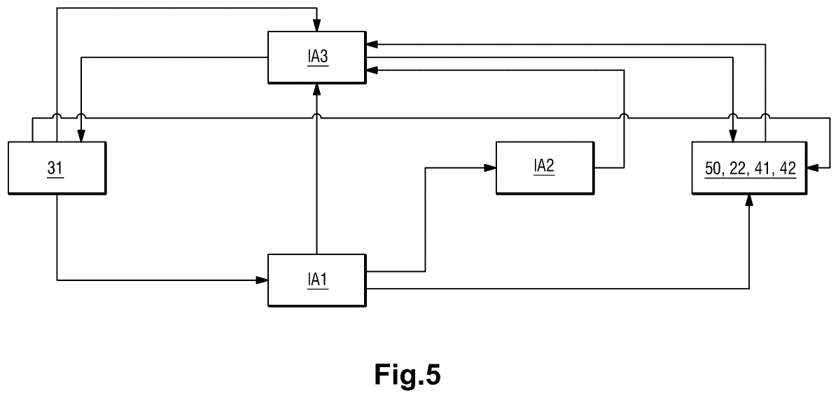

In reference more particularly to FIG. 4 and according to a second operating mode, by considering a detachment of three vehicles 1A, 1B, 1C arriving in front of a zone to be surveilled, the detachment commander controls the autonomous operating mode of their observing device. The third electronic unit 33 of the detachment commander's vehicle 1A is programmed to:
perform a scan of the space to be surveilled via the optronic sight 10;
detect the danger zones within the scanned surroundings; and
divide the scanned surroundings into a plurality of surveillance sectors S1, S2, S3 having equivalent densities of danger zones.

In this present example, danger detection comprises the step of forming a panoramic image Ip of the scanned surroundings and processing this image to search for boundary lines F forming the danger zones (image Ip′).

The division of the space to be surveilled into surveillance sectors comprises the steps of defining densities of boundary lines.

The densities of danger zones are calculated from the densities of boundary lines weighted according to a boundary type defined by the boundary lines and/or by a distance of the boundary lines from the device. For example, if a terrain or a forest is present at a short distance, the enemy's approach may be masked such that the danger represented by the corresponding boundary line is significant: the weighting coefficient is therefore high. If, by contrast, there is a large open area in the space to be surveilled, the enemy may approach from that side but their approach may be detected at long range: the weighting coefficient is therefore moderate. In addition, if there is impassable terrain in a sector, it is impossible for the enemy to approach: the weighting coefficient is therefore low.

The third electronic unit 33 of the detachment commander's vehicle 1A is programmed to assign a surveillance sector to the observing device of each of the other vehicles 1B, 1C and to communicate to each electronic unit 33, identification data of the sector that has been assigned to it. For this purpose, each electronic unit 33 is connected to a transceiver 60, e.g., radio type, allowing the electronic units 33 to exchange data.

The third electronic unit 33 is programmed to update the calculation of the densities of danger zones and the corresponding division of the sectors S1, S2, S3 to be surveilled according to at least one of the following events:
changing the number of adjacent vehicles equipped with an observing device (e.g., due to the decommissioning of a device or the arrival of a new vehicle equipped with a compatible observing device);
receiving a clock signal ensuring a pre-determined periodicity of the update;
increasing or decreasing the density of danger zones within one sector.

The program run by the third electronic unit 33 preferably comprises artificial intelligence modules.

Thus, the images captured and the telemetry measurements performed by the optronic sight 10 in autonomous operating mode are processed by a perception artificial intelligence module AI1 that is arranged to:
detect the targets;
determine the positions of the targets;
determine a classification of the targets into tactical elements;
form images in which the targets are highlighted;
detect the points of interest;
determine the positions of the points of interest;
determine a classification of the points of interest;
determine the age of the latest observation of each point of interest.

The position of the points of interest, their classification and the information of temporal validity are used by a decision-making artificial intelligence module IA2 that is arranged to interpret the information in question from a tactical point of view to determine priority observation zones.

The positions and classifications of the targets, and the priority observation zones are used by a decision-making artificial intelligence module AI3 arranged to plan the surveillance based on the information in question and to determine the image-capture parameters that correspond to this planning and that are communicated to the first electronic unit 31.

The first electronic unit 31 sends status data from the optronic sight 10 to the decision-making artificial intelligence module IA3 and site, bearing and North data from the optronic sight 10 to the screen 50.

The decision-making artificial intelligence module AI3 sends planning information to the screen 50 and receives commands from the interfaces 41, 42 and from the touch part of the screen 50.

Naturally, the invention is not limited to the embodiment described, but covers any variant coming within the scope of the invention as defined by the claims.

In particular, the device may have a structure different from that described above.

The electronic units may be part of a common electronic circuit or of electronic circuits that are different.

The electronic units 31 and 32 may be connected to each other directly by electrical conductors or by radio link.

The autonomous optronic operating mode may have only some of the above functions. For example, only one of the operating modes, in whole or in part, may be implemented.

The device may comprise one or more control instruments, in the form of one or more levers, a keyboard, an orientable ball, etc.

The number and type of optronic sensors may be different from those described: for example, there may be a day sensor and night sensor, light intensifier or thermal camera, etc.

The danger zones, densities of danger zones and levels of danger may be determined in a different way than those described, for example, by taking into account only the points of interest or threats detected.

The platform on which the device of the invention is mounted may be a mobile platform—i.e., any type of land, water or air vehicle—or a fixed platform, such as a building. In the case of a land vehicle, this vehicle may be wheeled or tracked, with or without a turret.

1. A device for observing the surroundings of a platform on which the device is mounted, the device comprising optronic equipment and an optical sight, the optronic sight comprising a rotating support that carries at least one optronic sensor and that is equipped with a motorisation system making it possible to orientate the optronic sensor, the optronic sensor and motorisation system being connected to a first electronic unit arranged for controlling acquisition according to image-capture parameters, the optical sight being orientable and connected to a second electronic unit arranged to communicate to the first electronic control unit the image-capture parameters of the optical sight, the first electronic unit having a slave mode of operation whereby the optronic equipment is controlled to make acquisitions in accordance with the image-capture parameters of the optical sight when the optical sight is used by an operator, wherein the first electronic unit is arranged to have at least one autonomous operating mode wherein the optronic equipment is controlled to make acquisitions independently of the image-capture parameters of the optical sight while the optical sight is used by an operator.

2. The device according to claim 1, wherein, in autonomous operating mode, the optronic equipment is controlled to be pointed in a different direction from that of the optical sight and the device comprises a third electronic unit arranged to process the images supplied by the optronic equipment, detect points and/or zones of interest therein and present, to the operator, information relating to the detected points and/or zones of interest.

3. The device according to claim 2, wherein the optronic equipment comprises a range-finder controls, in autonomous operating mode, the optronic equipment to perform a telemetry mapping of the detected points of interest.

4. The device according to claim 2, wherein the third electronic unit is arranged, in autonomous operating mode, to present the information on a screen adjacent to an output of the optical sight.

5. The device according to claim 4, wherein the third electronic unit is arranged such that the presentation of information relating to the detected points and/or zones of interest may be activated and deactivated by the operator.

6. The device according to claim 4, wherein the third electronic unit is arranged to determine contextualisation information making it possible to spatially connect the information relating to the detected points and/or zones of interest and the field of view covered by the optical sight and to present the contextualisation information with the information relating to the points of interest detected in the field of view covered by the optical sight.

7. The device according to claim 2, wherein the first electronic unit is arranged to, in autonomous operating mode, control the optronic equipment to perform a scan of the surroundings.

8. The device according to claim 7, wherein the third electronic unit is arranged to detect danger zones within the scanned surroundings.

9. The device according to claim 8, wherein the third electronic unit is arranged to divide the scanned surroundings into a plurality of surveillance sectors having equivalent densities of danger zones.

10. The device according to claim 8, wherein danger detection comprises the step of forming a panoramic image of the scanned surroundings and searching for boundary lines forming the danger zones, and the division into surveillance sectors comprises the steps of defining densities of boundary lines.

11. The device according to claim 10, wherein the densities of danger zones are calculated from the densities of boundary lines weighted according to a boundary type defined by the boundary lines and/or by a distance of the boundary lines from the device.

12. The device according to claim 9, wherein the third electronic unit is arranged to assign a surveillance sector to at least one observing device mounted on an adjacent platform and is connected to communication member with said at least one observing device mounted on an adjacent platform for transmitting to it identification data of the surveillance sector that has been assigned to it.

13. The device according to claim 12, wherein the third electronic unit is arranged to update the calculation of the densities of danger zones and the corresponding division of the sectors to be surveilled, according to at least one of the following events:
changing the number of devices mounted on the adjacent platforms;
receiving a clock signal ensuring a pre-determined periodicity of the update;
increasing or decreasing the density of danger zones in one of the sectors to be surveilled.

14. The device according to claim 2,
wherein the third electronic unit is arranged to, in autonomous operating mode, detect each target present in the field of view of the optronic equipment, assess a level of dangerousness of each target according to data from the target, and update the threat level periodically after a pre-determined period of time.

15. The device according to claim 14, wherein the third electronic unit is arranged to determine the following target data:
a target type from a target library;
a position of the target;
a trajectory of the target;
a weapon orientation of the target.

16. The device according to claim 2, wherein the third electronic unit is arranged to determine, in autonomous operating mode, a priority level of the zones to be observed according to a level of complexity of each zone and/or a level of dangerousness of each zone.

17. A vehicle having a body surmounted by a device according to claim 1.

18. The vehicle according to claim 17, wherein the device is mounted on a turret, mounted to pivot on the body.
